(19) United States
(12) Patent Application Publication
(10) Pub. No.: US 2020/0065731 A1
(43) Pub. Date: Feb. 27, 2020

(54) SYSTEM AND METHOD FOR AN IMPROVED CONSTRUCTION DESIGN SOFTWARE WITH LOCATION SPECIFIC SELECTIONS

(71) Applicant: Paul Ayres McKelvey, Irvine, CA (US)

(72) Inventor: Paul Ayres McKelvey, Irvine, CA (US)

(21) Appl. No.: 16/541,487

(22) Filed: Aug. 15, 2019

Related U.S. Application Data
(60) Provisional application No. 62/720,395, filed on Aug. 21, 2018.

(51) Int. Cl. G06Q 10/06; G06Q 50/08; G06Q 50/16

(52) U.S. Cl. CPC G06Q 10/06313; G06Q 50/165; G06Q 50/08; G06Q 10/06315

(57) ABSTRACT

An improved construction design system with location-specific selections that allow a user to rapidly identify, organize, manage and share construction project(s) material selections. The system and method comprise a propriety software for allowing a user to enter a project type and a series of locations to be constructed. The system interacts with such entries to auto-populate the project's data, and the user then adds to removes from the data as they prefer. The system allows the user to invite third-parties to the completed project at various permission levels, allowing them to view, edit, or dib on the project itself or on the component trades and/or locations. The software may be designed to work with residential, commercial, and industrial construction projects, as well as any project or process benefiting from rapid identification, organization and collaboration of material types, trade types and location categories.

### CROSS-REFERENCE TO RELATED APPLICATION

This application claims the benefit of co-pending U.S. Provisional Patent Application Ser. No. 62/720,395, filed Aug. 21, 2018, which is incorporated herein in its entirety.

### FIELD OF THE INVENTION

The present invention relates generally to software, and more particularly, to system and method for an improved construction design software with location-specific selections.

### BACKGROUND OF THE INVENTION

One of the most consistent and frustrating aspects of the construction process for contractors and project owners is getting all of the fixture and finish selections made ahead of time. Decisions on such fixtures and finishes often wait until the last minute and are ultimately made under a sense of urgency instead of being made under the calming guidance of organization and control.

Building permits require plans and specifications that specify information related to the size, scope, building, and structural details and energy performance as they relate to the technical aspects of building a project to current local building codes. Final selections regarding fixtures and finishes are not required by building departments to issue a building permit. As such, architects rarely work with their client to generate complete fixture and finish specifications. The selection process is left to the owner to accomplish on their own or, if their motivation and budget allows, with the help of a designer. Building owners often view hiring a designer as an expensive option. They also find organization and execution capabilities varying from one designer to another as they will vary from one building contractor to another.

To remedy such issues project management software solutions are available that allow a contractor, project owner, or designer to manage and organize individual projects. These solutions, though, do not focus or aid in identifying and organizing the fixture and finish section process. Instead, the process is usually accomplished on a project-by-project basis, where the contractor, project owner, or designer must manually apply the relevant information.

Therefore, there is a need in the art for an improved construction design software with location-specific selections that allows a user to automatically and rapidly identify all of the fixture and finish selections pertinent to their unique construction project.

### SUMMARY OF THE INVENTION

This summary is provided to introduce a selection of concepts in a simplified form that are further described below in the detailed description. This summary is not intended to identify key features of essential features of the claimed subject matter, nor is it intended to be used to limit the scope of the claimed subject matter. Furthermore, the claimed subject matter is not limited to implementations that solve any or all disadvantages noted in any part of this disclosure.

According to embodiments or examples of the present disclosure, an improved construction design software is disclosed.

In one aspect, the improved construction design software may comprise a project management software as it relates to the identification, organization, and implementation of project specific fixtures and finishes.

In another aspect, the improved construction design software may allow a user to select a location type with the software automatically identifying and categorizing all of the related building trades, finish materials, and fixtures that the associated building trades will use to build or renovate the selected location.

In another aspect, the improved construction design software may comprise a plurality of location-specific selections with the software automatically connecting and relating all of the associated building trades by location along with automatically connecting and relating all of the finish materials and fixture by building trade by selected locations.

In another aspect, the improved construction design software may correlate location-specific selections with associated specialized building trade selections.

In another aspect, the improved construction design software may correlate building trade specific selections with associated fixture and finish material selections.

In another aspect, the improved construction design software may correlate location-specific selections with associated specialized building trade selections along with associated fixture and finish material selections.

In another aspect, the improved construction design software may allow a user to rapidly identify, organize, and customize all fixture and finish selections by material type.

In another aspect, the improved construction design software may allow a user to rapidly identify, organize, and customize all fixture and finish selections by specific building trade by specific location or by all locations.

In another aspect, the improved construction design software may comprise a permission-based project sharing method.

In another aspect, the improved construction design software may comprise variations appropriate to residential, commercial, or industrial construction projects.

In another aspect, the improved software may comprise variations appropriate to manufacturing processes and materials, research processes and materials, educational and training processes and materials, medical processes and materials along with other various development processes and materials.

In another aspect, the improved construction design software may comprise variations appropriate to any project where types of materials and labor categories and sub categories are selectable.

As another example, disclosed are one or more storage machines holding instructions executable by one or more logic machines to carry out a method of construction design, the method comprising:

using at least one logic machine:

automatically determining receipt of a user input through a graphical user interface by automatically tracking user operation of the graphical user interface;

based on the user input, selecting a location type and automatically identifying and categorizing building trades, finish materials, and/or fixtures that associated building trades will use to build or renovate a selected location.

In another aspect, the method further includes automatically connecting and relating all associated building trades by location.

In another aspect, the method further includes automatically connecting and relating all finish materials and fixtures by building trade and selected locations.

In another aspect, the method further comprises correlating location-specific selections with associated specialized building trade selections.

In another aspect, the method further comprises correlating building trade specific selections with associated fixture and finish material selections.

In another aspect, the method further comprises using a user input to identify, organize, and customize all fixture and finish selections by material type.

In another aspect, the method further comprises a permission-based project sharing method for construction design.

In another aspect, a project type is selectable using the user input, where the project type includes residential, commercial, and/or industrial type projects, and where the method automatically configures a graphical user interface according to the project type.

In another aspect, the method further includes: in response to the user input, automatically returning location specific data relating to a project type selection, the project type selection including residential, commercial, and/or industrial project types, and automatically returning building trade specialties and finish and fixture materials related to a specific location used in constructing a selected location and/or selected project type.

In another aspect, the method further includes automatically generating a group of customized locations, trades, and materials relevant to a user's specific project, and automatically identifying trade and materials possibly related to constructing a particular location type, and further receiving user inputs to personalize said automatic generation steps and said automatic identification steps.

In another aspect, the method further includes presenting various views to a user, including “trade view by location” and/or “material view by trade” to expedite customization of a project.

In another aspect, various user inputs and data may be stored and recalled from a proprietary database that meta-analyzes received data to improve accuracy and efficiency of the method.

In another aspect, the method further comprises using a user input to customize a personalized database of locations, trades, materials and associations that establish desired relationships between one or more of the locations, trades and/or materials.

In another aspect, the method further comprises, once specific locations, trades, and/or materials for a given project have been identified and customized, using a user input to invite other users to view or edit the project;

wherein such an invitation includes allowing access to view, edit, and/or bid on the project or its component locations.

In another aspect, the method further includes automatically preparing a tab organized, binder-ready printout using location-specific user input selections, where “binder-ready” is defined as data having been formatted for assembly into a 3-ring project binder to enhance ease of use and create a professional layout.

In another aspect, the method further includes prompting a user to think of trades and materials that otherwise might be missed or forgotten.

In another aspect, the method further includes automatically identifying a type of facility, tooling, and/or materials needed for a construction project.

In another aspect, the method further comprises automatically identifying a type of material and labor categories associated with a specific project.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the claimed subject matter will hereinafter be described in conjunction with the appended drawings provided to illustrate and not to limit the scope of the claimed subject matter, where like designations denote like elements, and in which:

FIGS. 1A-1C schematically presents an improved construction design software method with location-specific selections, in accordance with aspects of the present disclosure;

FIG. 2 schematically presents a computing system configured to carry out and actualize methods and tasks described herein, in accordance with aspects of the present disclosure;

FIGS. 3A and 3B illustrate portions of the user interface of an improved construction design software with location-specific selections, in accordance with aspects of the present disclosure;

FIGS. 4A, 4B, 4C, and 4D illustrate further portions of the user interface of an improved construction design software with location-specific selections where a user selects and enters location names, in accordance with aspects of the present disclosure;

FIGS. 5A, 5B, and 5C illustrates a portion of the user interface of an improved construction design software with location-specific selections where a user enters location details, in accordance with aspects of the present disclosure; and

FIG. 6 illustrates a binder-ready printout from an improved construction design software with location-specific selections, in accordance with aspects of the present disclosure.

It is to be understood that like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

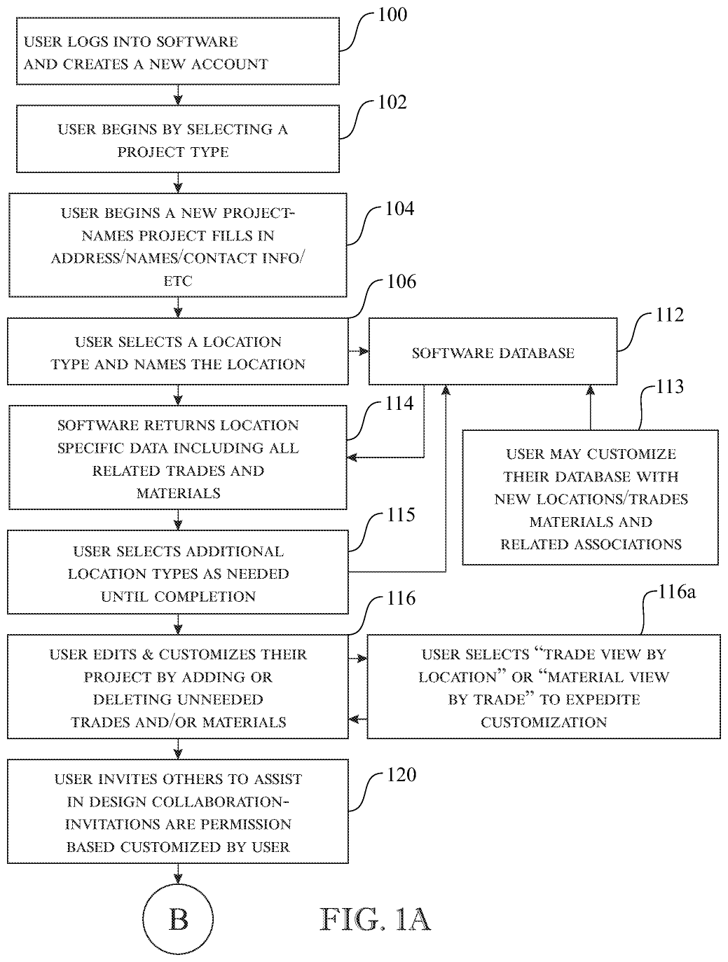

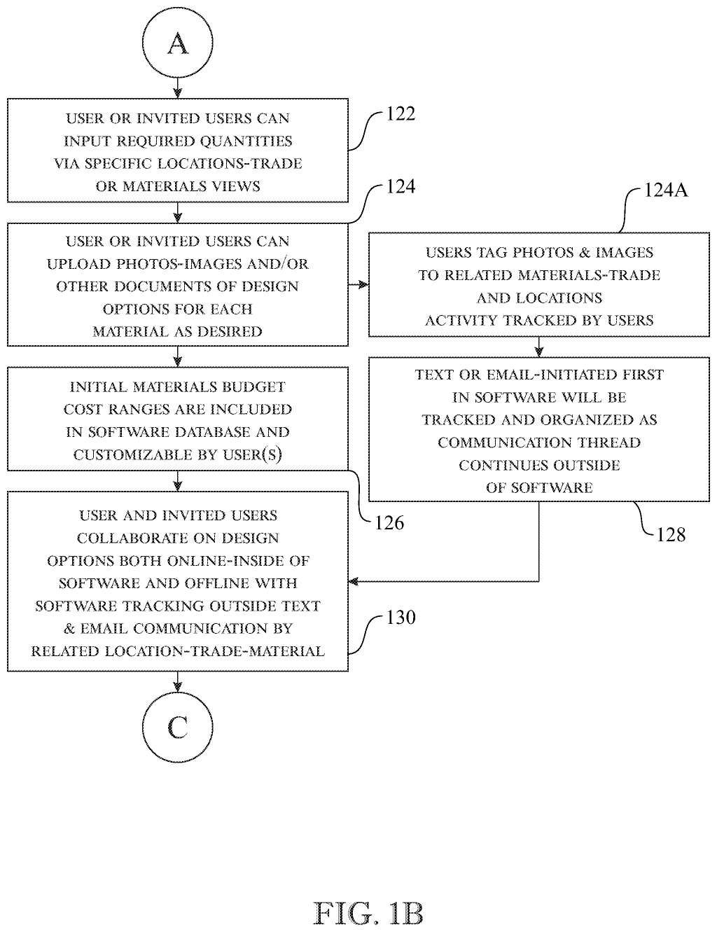

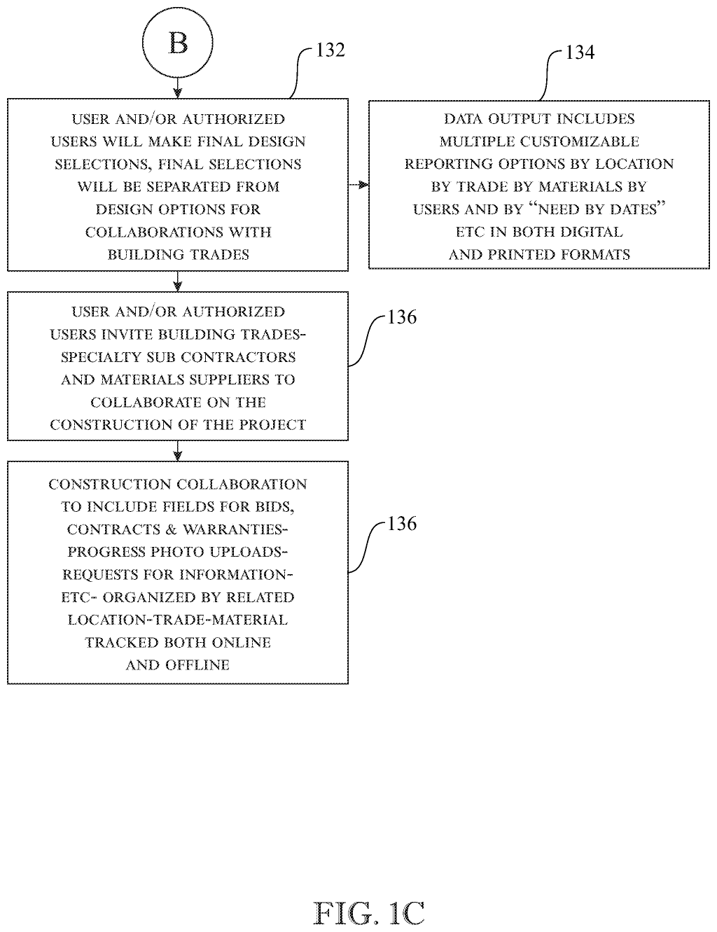

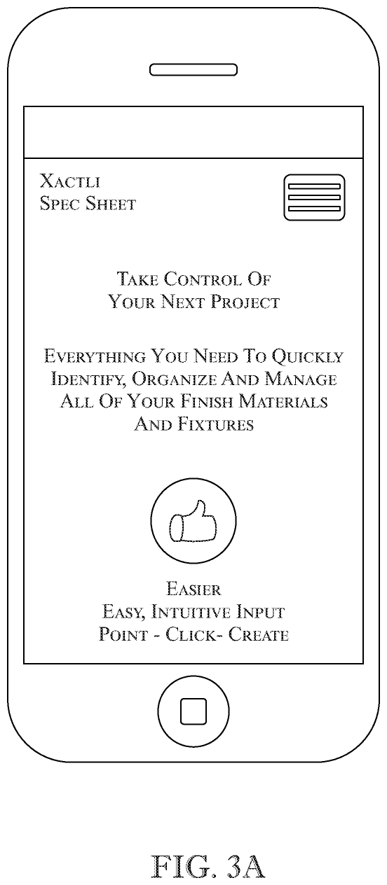

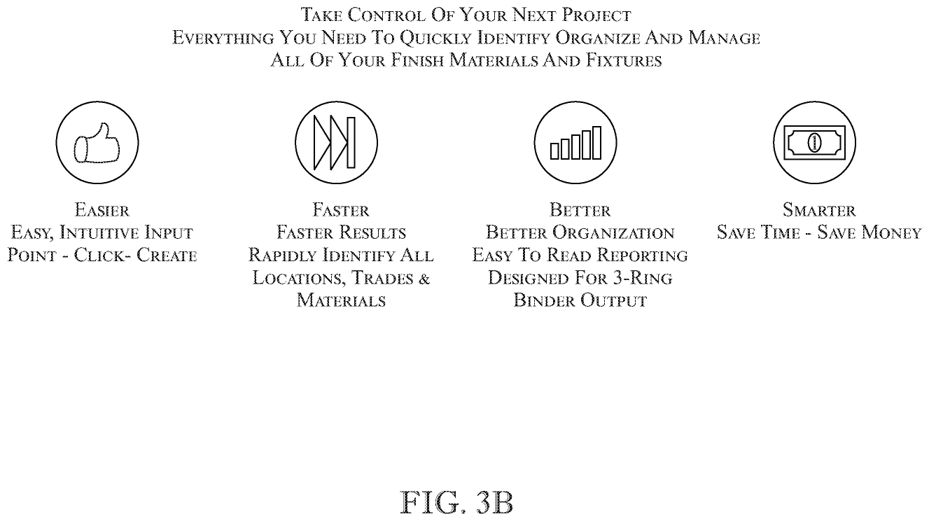

The illustrations of FIGS. 1A-1C, schematically present a system and method for an improved construction design software with location-specific selections. The system and method comprise an online software that allows a user, such as a property owner or building professional, to rapidly identify, organize, and customize all fixture and finish selections required to plan and build a unique construction project. As contemplated by the present invention, a user may begin by logging into the software 100 via the user interface, shown in FIGS. 3A and 3B. The software may then identify all fixture and finish selections by the following procedures.

It is to be understood that the herein disclosed systems and methods are structured, configured, and/or purposed to actualize operations for solving computing problems in construction design.

The user may begin a new project 102 within the software, and may select a project type 104, which may be a residential, commercial, industrial, or other appropriate project. The user may fill in the project name, address and contact information 104. The user may then select a location type 106 that they intend to renovate or construct, and may name the location consistent with the project 104. Once the location type 106 is selected it is submitted to the software 112. The software may automatically return all of the unique, location-specific data relating to these entries 114. The software may also return all building trade specialties and finish and fixture materials related to the specific location used in constructing such a location type. The user may then select and name a plurality of locations related to a single project. Such actions may result in a group of customized locations, trades, and materials relevant to the specific user's project. The software may be advantageous in that it may identify every trade and material possibly related to constructing a particular location type, and may further be personalized to the specific user's preferences.

The user may then add or remove location-specific data 116 relevant to the user's preferences utilizing various views “Trade view by Location” or “Material view by Trade” for example to expedite the customization 116a. Such various entries and data may be stored and recalled from a proprietary software database 112, and the stored collection of data may be meta-analyzed and altered to improve accuracy and efficiency of the overall system. The user may also customize their own database with new Locations, new Trades, new Materials and new Associations that establish the desired relationship between all three 113.

Once the specific locations, trades, and materials for a given project have been identified and customized, the user may invite others to view or edit the project 120. Such an invitation may comprise the ability to view, edit, or bid on the project or its component locations, and may be controllable by the user of the system. By way of example, the user may assign permission levels to certain invited parties that include the ability to view or edit the project as preferred. The user of the system may be provided access to the software via a subscription-based account, and the various third parties may also access the software via subscription-based accounts or via one-time access codes or hyperlinks.

The software itself may be designed to process data related to a variety of construction projects such as, residential, commercial or industrial projects. It may also be readily applied to any appropriate project or process requiring rapid identification and organization of materials by department (labor type) and by classification (location or component name). The software may, for example, be modified to process data related to the construction of manufacturing facilities, tooling and/or manufactured products themselves by identifying the labor and material categories by classification. The software may also, for example, be designed to process data related to research projects, medical procedures and/or educational and training procedures and their needed materials.

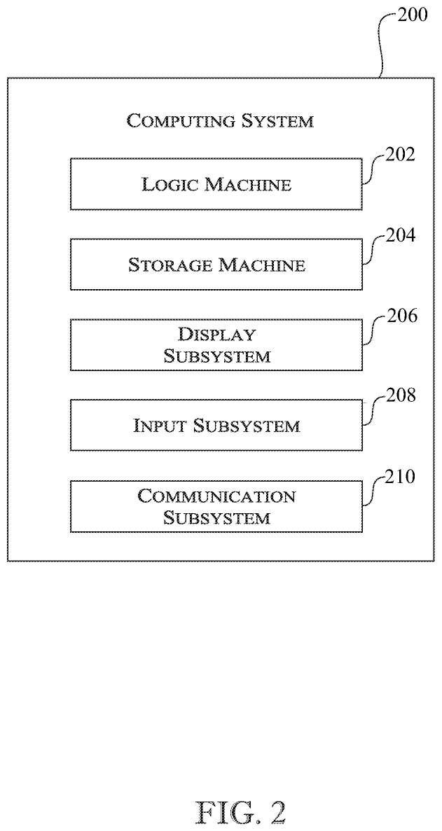

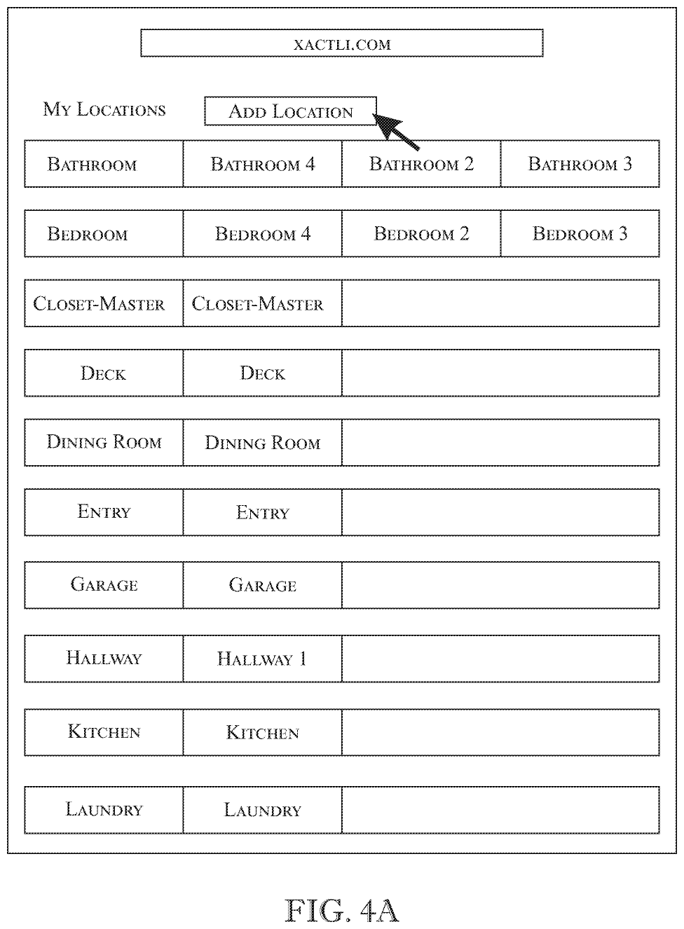

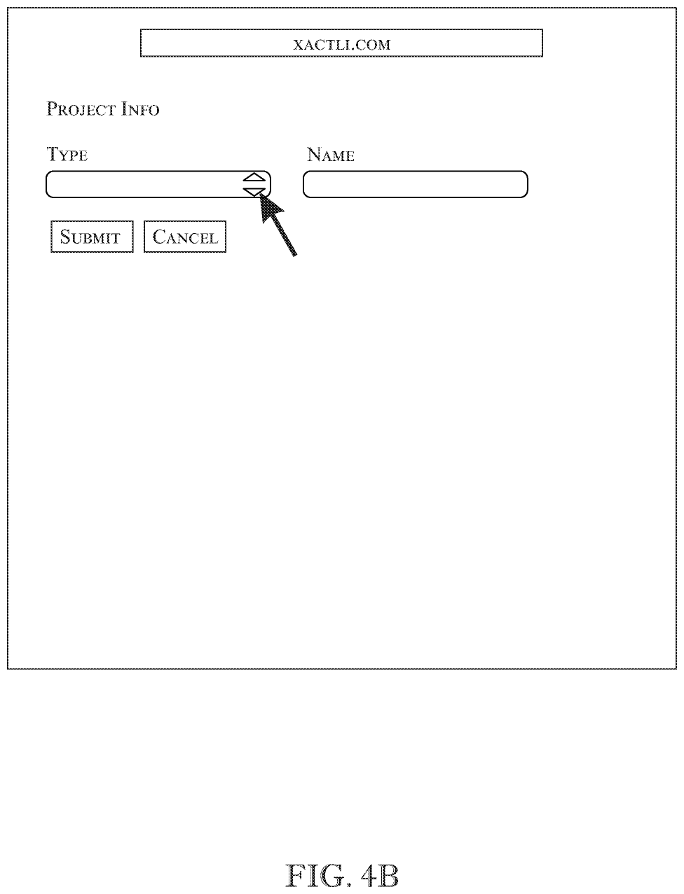

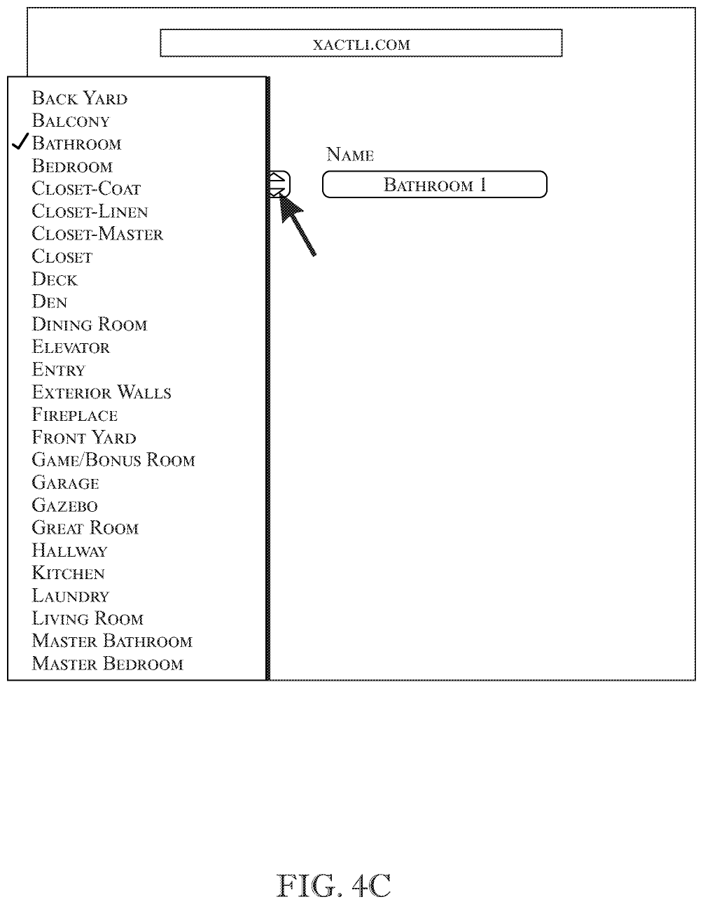

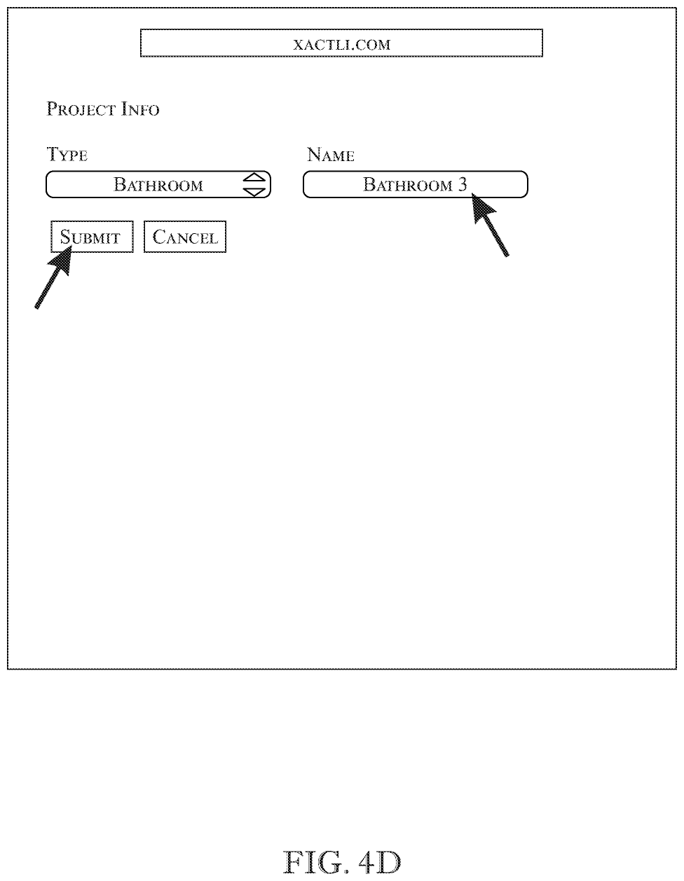

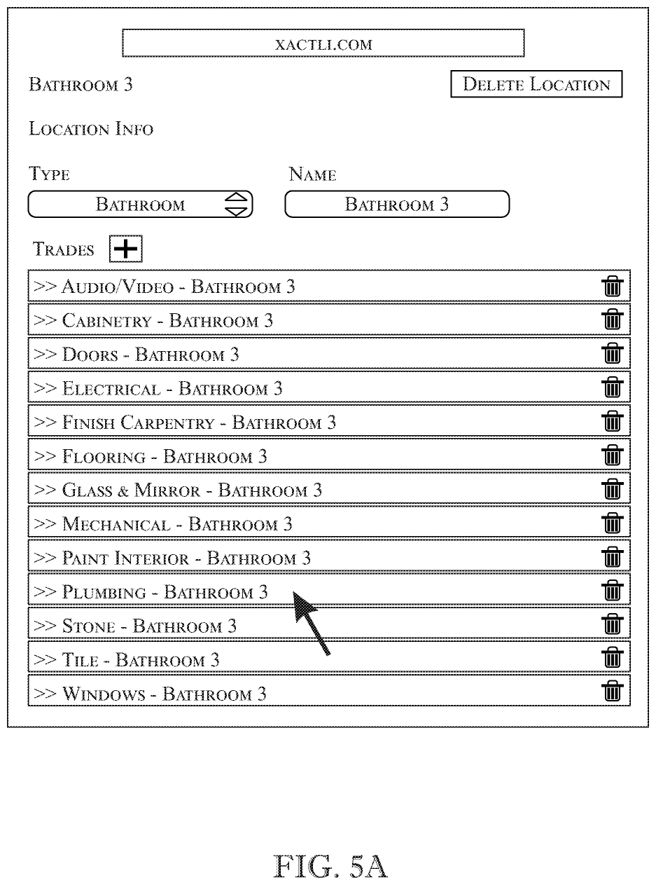

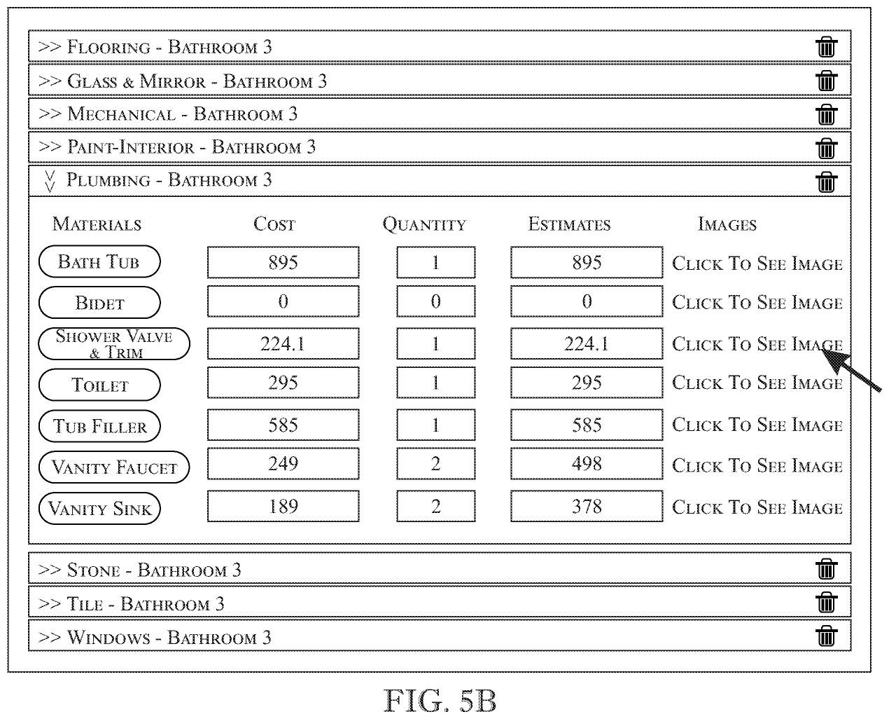

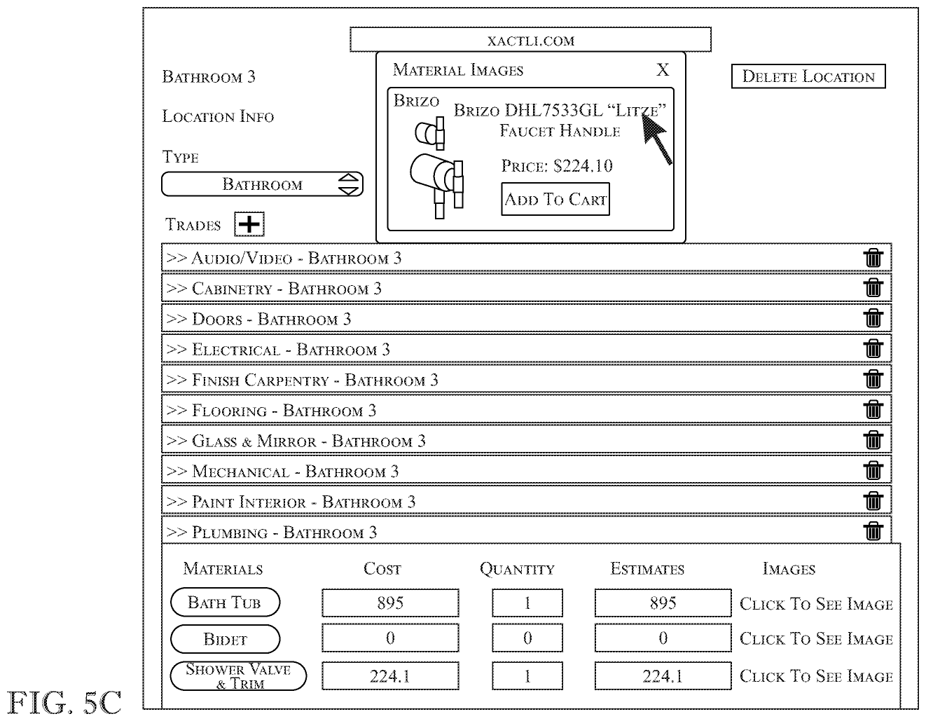

The illustration of FIG. 2 schematically presents a computing system that may represent an embodiment of the present invention. In some embodiments the method is executed on a computing system such as computing system 200 of FIG. 2. For example, storage machine 204 may hold instructions executable by logic machine 202 to provide the method to users. A primary memory may be cloud based on remote servers accessed via the internet. Display subsystem 206 may display the various elements of the method to participants. For example, display subsystem 206, storage machine 204, and logic machine 202 may be integrated such that the method may be executed while being displayed on a display screen. The input subsystem 208 may receive user input from participants to indicate the various choices or user inputs described above. The described method may be executed, provided or implemented to a user on one or more computing devices via a computer-program product such as via an application programming interface (API). FIG. 2 schematically shows a non-limiting exemplary embodiment of a computing system 200 that can enact the method described above. Computing system 200 may be any appropriate computing device such as a personal computer, tablet computing device, gaming device or console, mobile computing device, etc. Computing system 200 includes a logic machine 202 and a storage machine 204. Computing system 200 may include a display subsystem 206, input subsystem 208, and communication subsystem 210. Logic machine 202 may execute machine-readable instructions via one or more physical devices. For example, the logic machine 202 may be configured to execute instructions to perform tasks for a computer program. The logic machine may include one or more processors to execute machine-readable instructions. Storage machine 204 includes one or more physical devices configured to hold or store instructions executable by the logic machine to implement the method. When such methods and processes are implemented, the state of storage machine 204 may be changed to hold different data. For example, storage machine 204 may include memory devices such as cloud based remote servers accessed via the interne, internal hard disk drives, CD or DVD devices, or portable USB “thumb drives” or other similar digital memory devices. Display subsystem 206 may visually present data stored on storage machine 204. For example, display subsystem 206 may visually present data to form a graphical user interface (GUI). Input subsystem 208 may be configured to connect and receive input from devices such as a mouse, keyboard, or gaming controller. Communication subsystem 210 may be configured to enable system 200 to communicate with other computing devices. Communication subsystem 210 may include wired and/or wireless communication devices to facilitate networked communication. The illustrations of FIGS. 3A through 5C illustrate portions of the user interface of an improved construction design software with location-specific selections. As seen in FIGS. 3A and 3B, the user may be greeted with a login screen from which the user may log into the software 100 and begin use of the present system. As seen in FIGS. 4A-4D, the user may select a location type 106 for the project, or may combine multiple locations into a single project 115. The user may then submit such entries to the software, and the software may return location-specific data 114, as seen in FIGS. 5A-5C, related to the project, from which the user may add or remove location-specific data 116. Such various entries and data may be stored and recalled from a proprietary software database 112.

As a non-limiting example, the disclosure teaches action by a processor to execute a “determining step” that cannot be done mentally, for example by determining any of the disclosed data, informatic values, or states by automatically tracking other data, informatic values, or states. For example, the disclosed systems and methods may automatically determine a second (dependent) state or value by automatically tracking a first (independent) state or value, the second state automatically depending on the first state.

The disclosure includes the practical application of a processor (logic machine), and this practical application may include the receiving of an input through a graphical user interface (GUI) such as a user selection to execute one or more tasks or operations. Such a practical application may include the automatic operation of one or more data- or state-determining tasks in response to such a user selection or user input. The practical application as such may automatically execute any of the herein operations based on automatically determining any of the disclosed values, data, informatics, or states.

It is to be understood that the disclosed systems and methods provide a specific manner of automatically executing or actualizing the disclosed tasks, operations, or methods in a manner that is an improvement over known systems and solutions. In addition to being a practical application of machines, the disclosure includes an inventive concept that is not anticipated or obvious in view of known systems and methods.

Furthermore, the systems and methods disclosed herein are configured to solve technical problems in computing in the field of the disclosure as set forth in the background section, where the problems have attributes that hinder, limit, and/or prevent the features, aspects, or elements disclosed herein from being enabled and/or implemented. Therefore the disclosed technical solutions eliminate or alleviate these problems and positively contribute to the technical abilities of existing computing systems and methods.

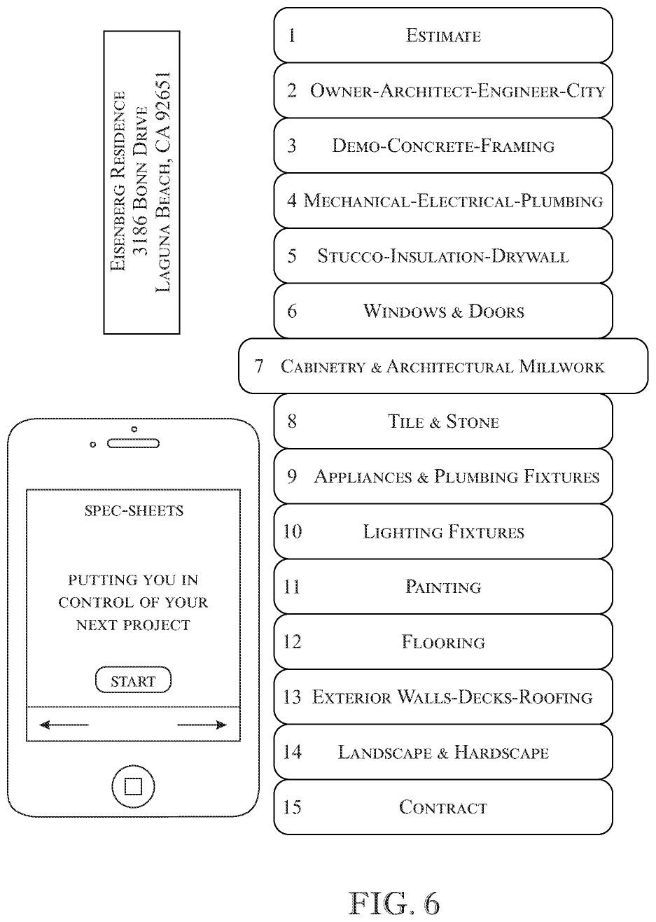

The illustration of FIG. 6 illustrates a a tab organized, binder-ready printout from an improved construction design software with location-specific selections. The present software may be designed to format data entered by the user so that it may be printed in a format ready for assembly into a 3-ring project binder to enhance ease of use and create a professional layout.

It is to be understood that the disclosed software may be customized at its back end to not only apply for other types of construction and manufacturing projects, it can also be customized to aid in the development of research projects, educational and training procedures and materials, possibly even medical processes and procedures.

In conclusion, disclosed is an online software that allows a user (property owner and/or building professional) to rapidly identify, organize and customize all fixture and finish selections required to build out their unique construction project. The primary novelty of the software is that it rapidly identifies all fixture and finish selections as follows. The user selects a location type that they plan on renovating and/or constructing then they name the location consistent with their project. Once named and submitted the software then pulls up all the unique trades related to building out that location type. The software also pulls up all the unique materials related to the trades used in building out that location type. The user then selects and names all of the different locations related to constructing their project. The result is a group of customized locations, trades and materials identified specifically for the user's project. One of the unique benefits of the software is that it will identify every trade and material possibly related to building out a unique location. This feature prompts the user to think of trades and materials that otherwise might be missed or forgotten. After consideration the user is then able to remove entire trades and/or individual materials within a trade that will not be part of the project. Once the specific Locations, Trades and Materials are identified and customized the user is then able to “invite” others (building professionals) to collaborate (or bid) on all or selected portions of their project. The user is able to assign permission levels include read/write permissions and specific trade and/or material permissions.

A unique, novel and valuable aspect of this software is that it allows the user to rapidly identify all of the fixture and finish selections they will have make and then allows them the ability to collaborate on a permission level all of the individual components of their project with local specialty material suppliers and sub-contractors.

The system's structure may accommodate any type of physical construction project. It may also accommodate any type of manufacturing process by identifying a type of facility, tooling and materials needed.

The system may be customized to simply and conveniently identify and organize the type of materials and labor categories associated with any project

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. One or more storage machines holding instructions executable by one or more logic machines to carry out a method of construction design, the method comprising:
using at least one logic machine:
automatically determining receipt of a user input through a graphical user interface by automatically tracking user operation of the graphical user interface; and
based on the user input, selecting a location type and automatically identifying and categorizing building trades, finish materials, and/or fixtures that associated building trades will use to build or renovate a selected location.

2. The method of claim 1, wherein the method further includes automatically connecting and relating all associated building trades by location.

3. The method of claim 1, wherein the method further includes automatically connecting and relating all finish materials and fixtures by building trade and selected locations.

4. The method of claim 1, wherein the method further comprises correlating location-specific selections with associated specialized building trade selections.

5. The method of claim 1, wherein the method further comprises correlating building trade specific selections with associated fixture and finish material selections.

6. The method of claim 1, wherein the method further comprises using a user input to rapidly identify, organize, and customize all fixture and finish selections by material type.

7. The method of claim 1, wherein the method further comprises a permission-based project sharing method for construction design.

8. The method of claim 1, wherein a project type is selectable using the user input, where the project type includes residential, commercial, and/or industrial type projects, and where the method automatically configures a graphical user interface according to the project type.

9. The method of claim 1, wherein the method further includes: in response to the user input, automatically returning location specific data relating to a project type selection, the project type selection including residential, commercial, and/or industrial project types, and automatically returning building trade specialties and finish and fixture materials related to a specific location used in constructing a selected location and/or selected project type.

10. The method of claim 1, wherein the method further includes automatically generating a group of customized locations, trades, and materials relevant to a user's specific project, and automatically identifying trade and materials possibly related to constructing a particular location type, and further receiving user inputs to personalize said automatic generation steps and said automatic identification steps.

11. The method of claim 1, wherein the method further includes presenting various views to a user, including “Trade View by Location”, “Material View by Trade” and/or “View Budget/Cost by location, by trade and/or by material” to expedite customization of a project

12. The method of claim 1, wherein various user inputs and data may be stored and recalled from a proprietary database that meta-analyzes received data to improve accuracy and efficiency of the method.

13. The method of claim 1, wherein the method further comprises using a user input to customize a personalized database of locations, trades, materials and associations that establish desired relationships between one or more of the locations, trades and/or materials.

14. The method of claim 1, wherein the method further comprises, once specific locations, trades, and/or materials for a given project have been identified and customized, using a user input to invite other users to view or edit the project;
wherein such an invitation includes allowing access to view, edit, and/or bid on the project or its component locations.

15. The method of claim 1, wherein the method further includes automatically preparing a tab organized, binder-ready printout using location-specific user input selections, where “binder-ready” is defined as data having been formatted for assembly into a 3-ring project binder to enhance ease of use and create a professional layout.

16. The method of claim 1, wherein the method further includes prompting a user to think of trades and materials that otherwise might be missed or forgotten.

17. The method of claim 1, wherein the method further includes automatically identifying type of tooling needed for a construction project.

18. The method of claim 1, wherein the method further comprises automatically identifying a type of material and labor categories associated with a specific project.

19. One or more storage machines holding instructions executable by one or more logic machines to carry out a method of construction design, the method comprising:
using at least one logic machine:
automatically determining receipt of a user input through a graphical user interface by automatically tracking user operation of the graphical user interface;
based on the user input, selecting a location type and automatically identifying and categorizing building trades, finish materials, and/or fixtures that associated building trades will use to build or renovate a selected location; and
wherein the method further includes automatically connecting and relating all associated building trades by location.

20. One or more storage machines holding instructions executable by one or more logic machines to carry out a method of project design for manufacturing, research, medical, educational and/or training procedures and their needed materials, the method comprising:
using at least one logic machine:
automatically determining receipt of a user input through a graphical user interface by automatically tracking user operation of the graphical user interface;
based on the user input, selecting a parameter that the project is dependent on and automatically identifying and categorizing materials that will be used in the project based on the parameter selected by the user input.
